(19) United States
(12) Patent Application Publication
(10) Pub. No.: US 2010/0308185 A1
(43) Pub. Date: Dec. 9, 2010

(54) MONITOR SUPPORT ARM

(76) Inventor: May-Chung Huang, Kaoshiung City (TW)

Correspondence Address: May-Chung Huang;May-Chung Huang, 235 Chung - Ho Box 8-24 Taipei, Taiwan, R. O. C., 235 Chung - Ho Box 8-24 Taipei, Taiwan, R. O. C., Taipei, 235, omitted

(21) Appl. No.: 12/477,917

(22) Filed: Jun. 4, 2009

(51) Int. Cl. F16M 11/22

(52) U.S. Cl. 248/122.1

(57) ABSTRACT

A structure improvement for monitor support arm has a main supporting arm and an extending arm. The main supporting arm has an upper cover and a lower cover. The rear end of the upper cover and the lower cover is pivoted on a connecting seat. The connecting seat is pivoted firmly on a fixing seat fixed on a wall. The front ends of the upper cover and the lower cover is pivoted on an engaging seat. Springs using for supporting and adjusting the supporting strength are installed in the upper cover and the lower cover. The extending arm has an upper cover and a lower cover. The rear ends of the upper cover and the lower cover are pivoted on an engaging seat. The front ends of the upper cover and the lower cover are pivoted on a connecting seat. The front end of the connecting seat is installed on monitor fixing seat for suspending fixedly a monitor by using a shaft. A spring for supporting and adjusting is installed between the upper cover and the lower cover. The structure of the monitor support arm has characteristics of convenience and safety so that the monitor support arm is capable of adjusting angles freely as a user's own choice.

### FIELD OF THE INVENTION

The present invention relates to a structure improvement for monitor support arm, and in particular to be capable of flexible adjusting angles of monitor support arm depending on a user's own choice. The structure improvement for monitor support arm is convenient for operation and adjustment of a monitor so as to have a supporting arm with characteristics of structural convenience and safety.

### BACKGROUND OF THE INVENTION

Referring to FIGS. 1 and 2, the prior art of a monitor supporting arm 10 has a main supporting arm 11. The main supporting arm 11 has a fixing seat 12 for fixing the main supporting arm 11 on a wall by using a shaft 20 on the rear of the main supporting arm 11. The main supporting arm 11 is capable of turning to the right or the left by using the fixing seat 12. The main supporting arm 11 has an extending arm 13 capable of lifting up and turning around by using a shaft 20 on the front end of the main supporting arm 11. The front end of the extending arm 13 is pivoted on a monitor fixing seat 14 so that a monitor 30 is able to be fixed. Therefore, a user can adjust the monitor 30 fixed on the fixing seat depending on the use's own choice.

However, because the main supporting arm is capable of adjusting angles of the extending arm by using movable shaft established between the extending arm and main supporting arm so as to adjust angles of the monitor and improve the stability and safety of the main supporting arm, the adjusting angles of the extending arm can not be extremely large. Therefore, it may be not so convenient for a taller user or a shorter user. Besides, the main supporting arm could only be turned to the left or the right. If the main supporting arm is folded horizontally, it needs a larger space to receive the main supporting arm. The main supporting arm may be easy to hurt someone around it.

### SUMMARY OF THE INVENTION

The primary objective of the present invention is to improve the prior art of structure of a monitor support arm so as to provide a flexible adjusting angle of monitor support arm depending on a user's own choice. The structure improvement for monitor support arm is convenient for operation and adjustment of a monitor so as to have a supporting arm with characteristics of structural convenience and safety.

### BRIEF DESCRIPTION OF THE DRAWINGS

FIG. 1 is a perspective view of the main supporting arm of the prior art.

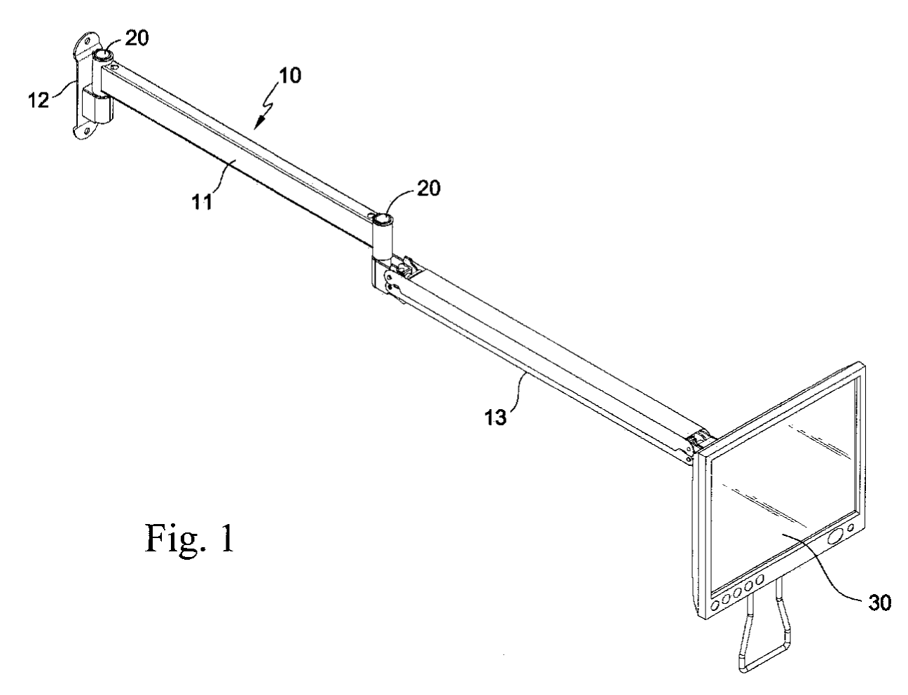

FIG. 2 is a cross-sectional view of the main supporting arm of the prior art.

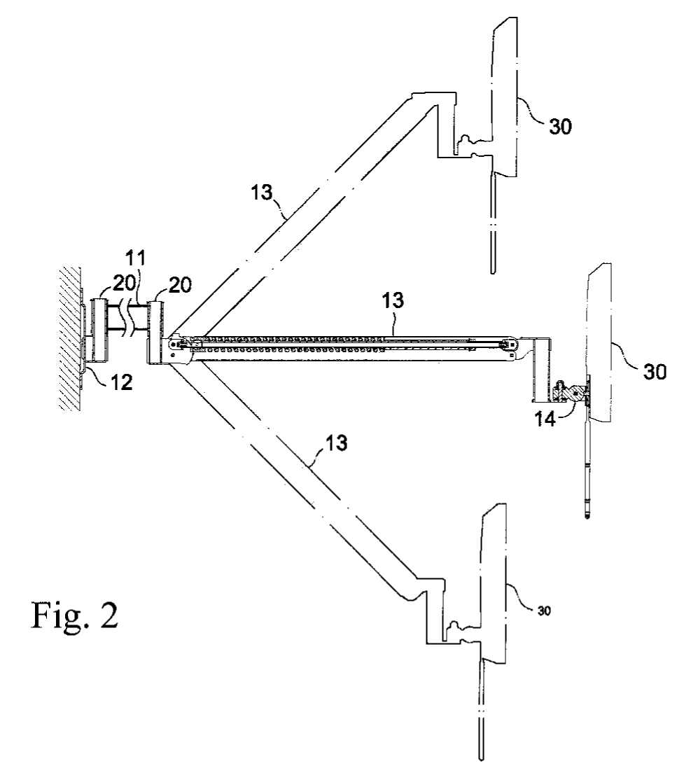

FIG. 3 is a perspective view of the present invention.

FIG. 4 is a cross-sectional view of the present invention.

FIG. 5 illustrates a cross-sectional view of vertical state composed by the horizontal main supporting arm and the turning downwards extending arm of the present invention.

FIG. 6 is illustrated with a cross-sectional view of vertical state composed by the turning upwards main supporting arm and the horizontal extending arm of the present invention.

FIG. 7 is illustrated with a cross sectional view of the present invention to be folded and stayed close to a wall.

### DETAILED DESCRIPTION OF THE PREFERRED EMBODIMENTS

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

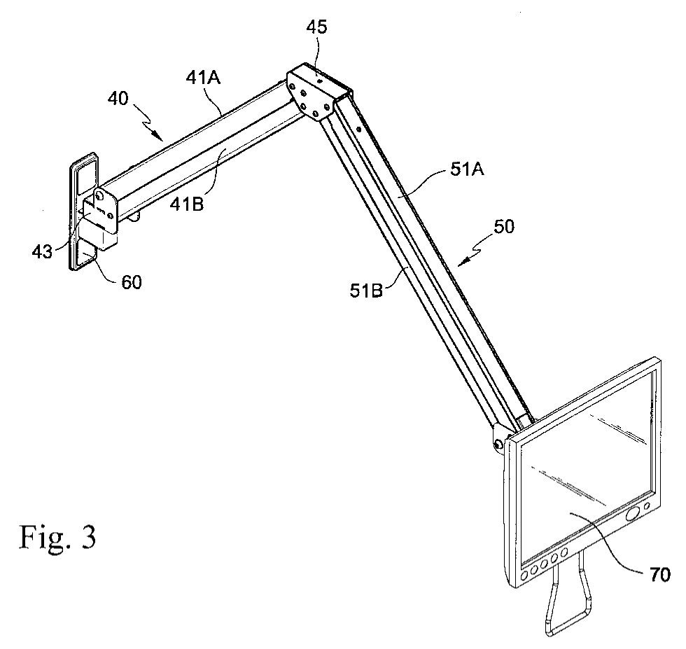

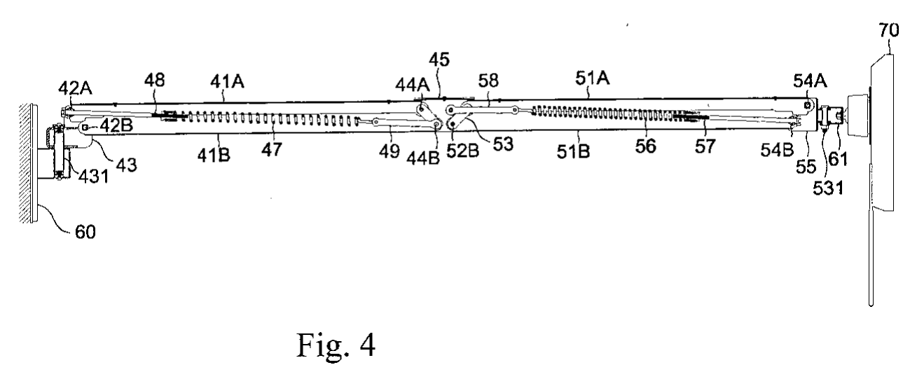

Referring to FIG. 3, a monitor supporting arm of the embodiment comprises a main supporting arm 40 and a extending arm 50 pivoted on the front end of the main supporting arm 40. Wherein the main supporting arm 40, please referring to FIGS. 4 to 6, comprises an upper cover 41A and a lower cover 41B. The rear ends of the upper cover 41A and the lower cover 41B are pivoted on a connecting seat 43 by using respectively a movable pivot 42A and a movable pivot 42B. The connecting seat 43 is fixed on a fixing seat 13 60 by using a shaft 431 to fix the connecting seat 43 on a wall so that the main supporting arm 11 is capable of turning left or right in use of the shaft 431. The front ends of the upper cover 41A and the lower cover 41B are pivoted on an engaging seat 45 by using respectively the movable pivot 44A and the movable pivot 44B. The upper cover 41A and the lower cover 41B are connected with a connecting shaft 46 by through the movable pivot 44A and the movable pivot 44B so as to enhance the spacing of the upper cover 41A and lower cover 41B. Besides, a supporting springs 47 is installed between the upper cover 41A and the lower cover 41B. The end of the springs 47 is fixed and connected with a thread shaft 48. The other end of the thread shaft 48 is pivoted firmly on the movable pivot 42A. The front end of the springs 47 is pivoted on the movable pivot 44B using for connecting with the lower cover 41B and the engaging seat 45. Therefore, the main supporting arm 40 is capable of turning and lifting upwards by using the movable pivot 42A and the movable pivot 42B. In addition, the upper cover 41A and the lower cover 41B are capable of spacing moveably so as to prevent form separation by using the engaging seat 45 to engage firmly the upper cover 41A and the lower cover 41B.

In the preferred embodiment, the front end of the springs 47 is connected with a connecting handle 49. The other end of the connecting handle 49 is pivoted on the movable pivot 44B installed on the lower cover 41B and the engaging seat 45 so that the supporting strength and endurance of the springs 47 are improved.

The extending arm 50, please referring to FIGS. 4 to 6, comprises an upper cover 51A and a lower cover 51B. The rear ends of the upper cover 51A and the lower cover 51B are pivoted on the engaging seat 45 by using respectively the movable pivot 52A and the movable pivot 52B. Both of the movable pivot 52A and the movable pivot 52B are connected respectively with the upper cover 41A and the lower cover 41B by using a connecting shaft 53.

In order to increase the spacing of the upper cover 51A and the lower cover 51B, the rear ends of upper cover 51A and lower cover 51B are pivoted on a connecting seat 55 by using respectively the movable pivot 54A and the movable pivot 54B. The front end of the connecting seat 55 is pivoted on a monitor fixing seat 60 by using a shaft 611 to fix the monitor 70 so that the monitor fixing seat 61 is capable of turning to the left or right by using the shaft 611. Besides, a supporting springs 56 is installed between the upper cover 51A and the lower cover 51B. The front end of the springs 56 is connected and fixed on a thread shaft 57. The end of the thread shaft 57 is pivoted firmly on the engaging seat 45 by using a movable pivot. Therefore, the extending arm 50 is capable of turning downwards by using the movable pivot 52A and the movable pivot 52B. Besides, the upper cover 51A and the lower cover 51B is capable of spacing movably so as not to be separated, by using the upper cover 51A and the lower cover 51B to be fixed on the engaging seat 45.

On another preferred embodiment, the end of the springs 56 is connected with a connecting handle 56. The other end of the connecting handle 56 is pivoted on the engaging seat 45 by using a movable pivot so as to improve the supporting strength and endurance of the springs 56.

On another preferred embodiment, both of the thread shaft 48 and the thread shaft 58, having respectively a thread nut 80 for each thread shaft, are pivoted firmly on the two ends of the movable pivot 42A and the movable pivot 54A so as to adjust the supporting strength of the springs 47 and the springs 56.

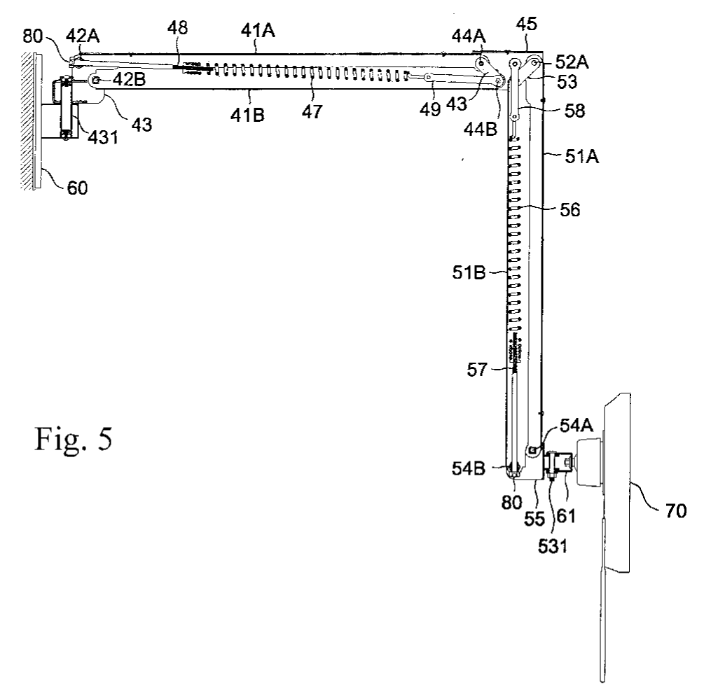

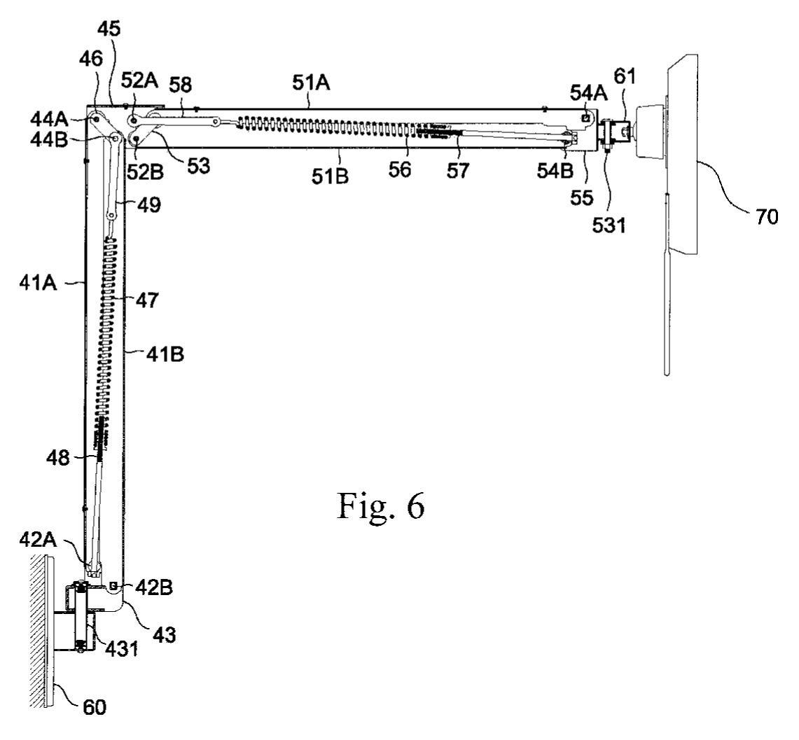

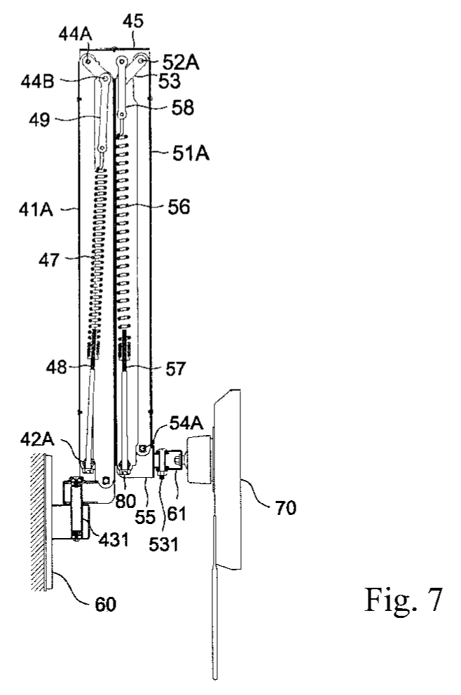

By using the above-mentioned structural design, the main supporting arm 40 is capable of turning upwards by using the both of the movable pivot 42A and the movable pivot 42B. The extending arm 50 is capable of turning downwards by using the movable pivot 52A and the movable pivot 52B so as to adjust the angle of the monitor 70 as a user's own choice. Referring to FIG. 4, the main supporting arm 40 is capable of turning downwards to be formed as a horizontal shape by using both of the movable pivot 42A and the movable pivot 42B. Besides, referring to FIG. 5, the extending arm 50 is capable of turning downwards to be formed as a vertical shape by using the movable pivot 52A and the movable pivot 52B so as to be more convenient for a shorter user. Referring to FIG. 6, the extending arm 50 is capable of turning downwards to be formed as a vertical shape by using the movable pivot 42A and the movable pivot 42B so as to be more convenient for a taller user. By using the supporting strength of both of the springs 47 and springs 56 and the spacing movably of both of the upper cover 41A and the lower cover 41B, the main supporting arm 40 and the extending arm 50 are capable of moving accurately and fixing firmly to a specific height, avoiding to have the situation of dislocation. Besides, the angles of the monitor 70 are capable of adjusting freely, by using the of function of free adjustment of the left and the right between the main supporting arm 40 and the fixing seat 60, and between the extending arm 50 and the monitor fixing seat so that the angles of the monitor 30 is capable of adjusting freely. In addition, referring to FIG. 7, whiling the supporting arm of the monitor is folded, the supporting arm 40 should be turned upwards by using both of the movable pivot 44A and the movable pivot 44B. The extending arm 50 should be turned downwards by using the movable pivot 54A and the movable pivot 54B. Therefore, the supporting arm of the monitor is capable of staying vertically close to a wall. Comparing to the prior art, which the supporting arm of the monitor is folded horizontally, the present invention is more convenient and safer.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claim is:

1. A monitor support arm comprising:
a main supporting arm having a upper cover and a lower cover;
the rear ends of the upper cover and the lower cover being pivoted on a connecting seat by using movable pivots;
the connecting seat being pivoted firmly by using a shaft and a fixing seat being fixed on a wall so that the main supporting arm being capable of turning the left or right around by using the shaft;
the front ends of the upper cover and the lower cover having respectively an engaging seat by pivoting with a movable pivot;
the upper cover and the lower cover having supporting springs;
the rear end of the springs being connected firmly to a thread shaft;
the end of the thread shaft being pivoted fixedly on the movable pivot;
the front end of the springs being pivoted on the movable pivot between the lower cover and the engaging seat;
an extending arm having a upper cover and a lower cover; the rear ends of the upper cover and the lower cover being pivoted on a engaging seat by using a movable pivot; the front ends of the upper cover and the lower cover being pivoted respectively on a connecting seat by using a movable pivot;
the front end of the connecting seat being pivoted on a monitor fixing seat for suspending firmly the monitor by using a shaft so that the monitor fixing seat being capable of turning the left or right around by using the shaft; supporting springs being installed between the upper cover and the lower cover;
the end of the springs being pivoted on the engaging seat by using a movable pivot; the front end of the springs being pivoted firmly on the engaging seat by using a movable pivot; the front end of the springs being connected firmly with a thread shaft; the end of the thread shaft being pivoted exactly on the movable pivot;
wherein the structure improvement for monitor support arm is capable of providing a adjusting and operational convenience for a user so that the user is able to adjust freely angles of the monitor support arm; and the supporting arm having the characteristics of convenience and safety for the user.

2. The monitor support arm as claimed in claim 1, wherein the upper cover and the lower cover of the main supporting arm and the movable pivot connecting with the engaging seat are also pivoted on a connecting shaft so as to increase the scale of spacing movably of the upper cover and the lower cover.

3. The monitor support arm as claimed in claim 1, wherein the upper cover and the lower cover of the extending arm and the movable pivot connecting with the engaging seat are also pivoted on a connecting shaft so as to increase the scale of spacing movably of the upper cover and the lower cover.

4. The monitor support arm as claimed in claim 1, wherein the front end of the main supporting arm is pivoted on the engaging seat by using a connecting handle.

5. The monitor support arm as claimed in claim 1, wherein the end of the springs of the extending arm is pivoted on the engaging seat by using a connecting handle.

6. The monitor support arm as claimed in claim 1, wherein each thread shaft with the fixing end of the movable pivot is pivoted on a thread nut for providing an adjusting supporting strength of the two springs.
